(19) United States
(12) Patent Application Publication
(10) Pub. No.: US 2011/0219625 A1
(43) Pub. Date: Sep. 15, 2011

(54) SHAVER HEAD

(75) Inventor: Richard Wayne Bryan, Manurewa (NZ)

(73) Assignee: CLOSE CUT CO LIMITED, Manukau (NZ)

(21) Appl. No.: 13/129,117

(22) PCT Filed: Nov. 12, 2009
(86) PCT No.: PCT/NZ2009/000249

§ 371 Date: May 12, 2011

(30) Foreign Application Priority Data
Nov. 13, 2008 (NZ) 572833

(51) Int. Cl. B26B 21/40; B26B 21/56

(52) U.S. Cl. 30/50; 30/346.5

(57) ABSTRACT

The present invention relates to a shaver head for a rotary razor comprising a central axle and at least two spaced apart hubs extending from the axle. Each hub mounts a plurality of elongate blades such that the blades are mounted in a manner to each extend, in their elongate direction, parallel to each other and parallel to the central axle.

### FIELD OF INVENTION

The present invention relates to rotary razors. More particularly but not exclusively it relates to the head of rotary razors.

### BACKGROUND

A rotary razor is an alternative to the common disposable razor. Rotary razors commonly have a rotatable razor blade head. The razor blade heads may have multiple faces with one or more blades located on each face. At any time, one face may be exposed to present one or more blades for use. When the user has used the razor blade(s) located on one face of the rotatable razor blade head they may then rotate the head so that new razor blade(s) are exposed for use. After all of the razor blades have been used the razor may be discarded, or the blade head may be replaced. Such a system is described, for example in U.S. Pat. No. 3,722,091.

Commonly, the heads of rotary razors are a substantially cylindrical, constant cross sectional shape with blades mounted around the periphery. Such heads may be difficult to clean, as the constant cross section means there is no space behind the blades for hair and/or excess shaving product to wash away.

Some rotary shaver heads require multiple recesses in each face for securing the blades. Such a design can be difficult to manufacture, as the moulds required to produce the heads must be complex and intricate to allow for the multiple recesses.

In this specification, where references has been made to external sources of information, including patent specifications and other documents, this is generally for the purpose of providing a context for discussing the features of the present invention. Unless stated otherwise, reference to such sources of information is not to be construed, in any jurisdiction, as an admission that such sources of information are prior art of form part of the common general knowledge in the art.

Accordingly, it is an object of the present invention to provide a razor which overcomes or at least ameliorates some of the abovementioned disadvantages or which at least provides the public with a useful choice.

### BRIEF DESCRIPTION OF THE INVENTION

In a first aspect the present invention consists in a shaver head for a rotary razor comprising:

a central axle,

at least two spaced apart hubs extending from said axle,

wherein each hub mounts a plurality of elongate blades such that the blades are mounted in a manner to each extend, in their elongate direction, parallel to each other and parallel to the central axle.

Preferably the blades do not contact the central axle and are positioned spaced away from the central axle to facilitate a cleaning of the blades by water that can circulate between the blades and the central axle.

Preferably the blades are supported by each of the hubs only.

Preferably the blades are mounted to not contact each other.

Preferably the blades are of a sheet metal.

Preferably the central axle comprises of multiple parts each part including one of the hubs, wherein each axle part can engage with (and preferably to) the other axle parts to form a central axle assembly.

Preferably each hub is of a polygonal shape that presents at least three sides, at each of which a plurality of blades are mounted to provide a multi faceted blade head each of at least two blades that can be presented at any one time for shaving purposes.

Preferably the blades include a straight cutting edge parallel to the elongate direction.

In a further aspect the present invention consists in a blade mount for mounting blades to define a rotary razor, said mount comprising:

a central axle,

at least two spaced apart hubs extending from said axle,

wherein each hub is adapted to mount a plurality of elongate blades such that the blades are mounted in a manner to each extend, in their elongate direction, parallel to each other and parallel to the central axle.

Preferably the blades do not contact the central axle and are positioned spaced away from the central axle to facilitate a cleaning of the blades by water that can circulate between the blades and the central axle.

Preferably the blades are supported by each of the hubs only.

Preferably the blades can be mounted to not contact each other.

Preferably the blades are of a sheet metal.

Preferably the central axle comprises of multiple parts each part including one of the hubs, wherein each axle part can engage with (and preferably to) the other axle parts to form a central axle assembly.

Preferably each hub is of a polygonal shape that presents at least three sides, at each of which a plurality of blades can be mounted to provide a multi faceted blade head each of at least two blades that can be presented at any one time for shaving purposes.

Preferably the blades include a straight cutting edge parallel to the elongate direction.

In a further aspect the present invention consists in a shaver head as herein described with reference to any one or more of the accompanying representations.

In a further aspect the present invention consists in a blade mount as herein described with reference to any one or more of the accompanying representations.

Other aspects of the invention may become apparent from the following description which is given by way of example only and with reference to the accompanying drawings.

As used herein the term “and/or” means “and” or “or”, or both.

As used herein “(s)” following a noun means the plural and/or singular forms of the noun.

The term “comprising” as used in this specification means “consisting at least in part of”. When interpreting statements in this specification which include that term, the features, prefaced by that term in each statement, all need to be present but other features can also be present. Related terms such as “comprise” and “comprised” are to be interpreted in the same manner.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which the invention relates, such known equivalents are deemed to be incorporated herein as if individually set forth.

### BRIEF DESCRIPTION OF THE DRAWINGS

The invention will now be described by way of example only and with reference to the drawings in which:

FIG. 1 is a perspective view of a shaver head,

FIG. 2 is another perspective view of a shaver head,

FIG. 3 is an exploded assembly view of a shaver head showing the parts that make up the head and the blades to be located on the head,

FIG. 4 is a side view of the exploded assembly view of FIG. 3.

FIG. 5 is a side view of the shaver head of FIG. 1 showing the locations of the cross sections A-A and B-B,

FIG. 6 is a cross-sectional view through A-A,

FIG. 7 is an end view of the shaver head of FIG. 1,

FIG. 8 is a cross-sectional view through B-B,

FIG. 9 is an end view of a shaver head that has four sides with blades mounted thereon,

FIG. 10 is an end view of a shaver head that has five sides with blades mounted thereon,

FIG. 11 is an end view of a shaver head that has six sides with blades mounted thereon,

FIG. 12 is an end view of a shaver head that has seven sides with blades mounted thereon,

FIG. 13 is an end view of a shaver head that has eight sides with blades mounted thereon,

FIG. 14 is an end view of a shaver head that has nine sides with blades mounted thereon,

FIG. 15 is an end view of a shaver head that has ten sides with blades mounted thereon,

FIG. 16 is an end view of a shaver head that has eleven sides with blades mounted thereon,

FIG. 17 is an end view of a shaver head that has twelve sides with blades mounted thereon, and

FIG. 18 is an end view of a round shaver head.

### DETAILED DESCRIPTION OF THE INVENTION

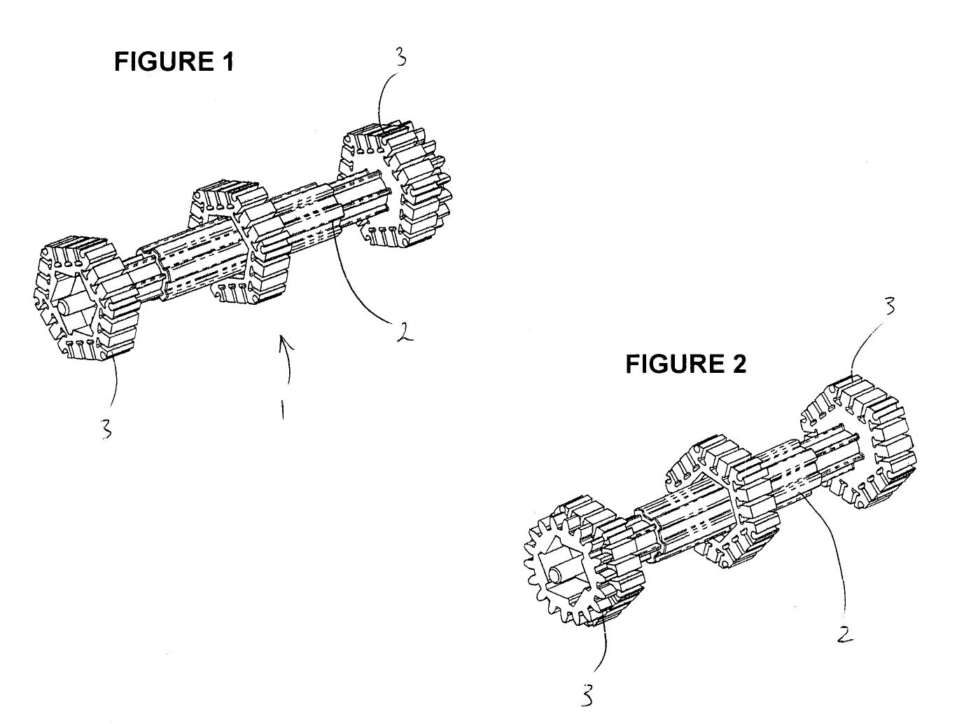

With reference to FIGS. 1 and 2 there is shown a shaver head 1 for use in a rotary shaver. The shaver head 1 has a central axle 2, and at least two hubs 3 extending from the axle 2. Preferably there are three hubs 3 extending from the axle 2. Each hub 3 may be any shape, and have any number of sides around its periphery.

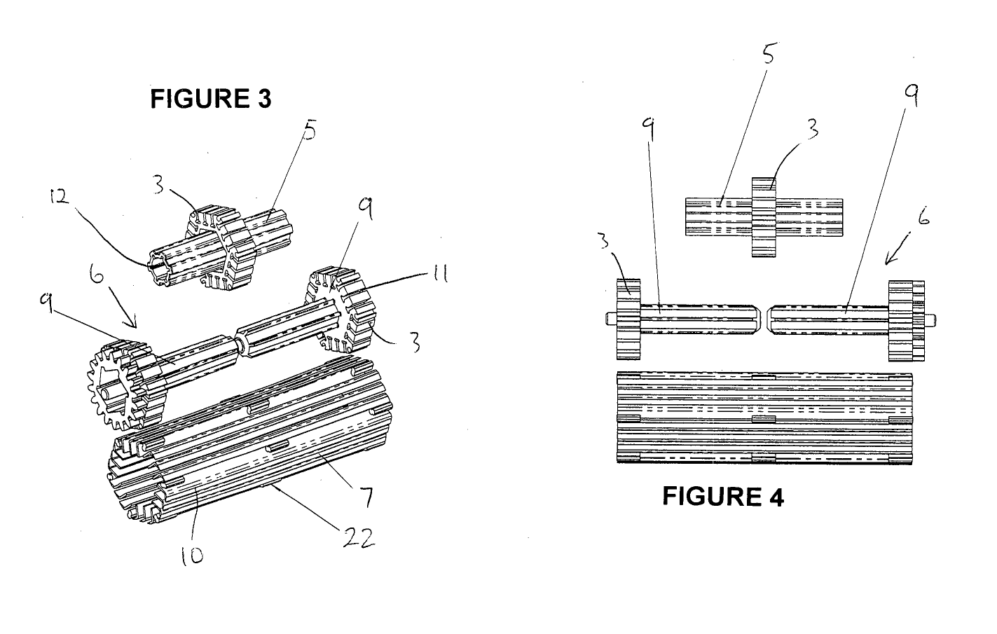

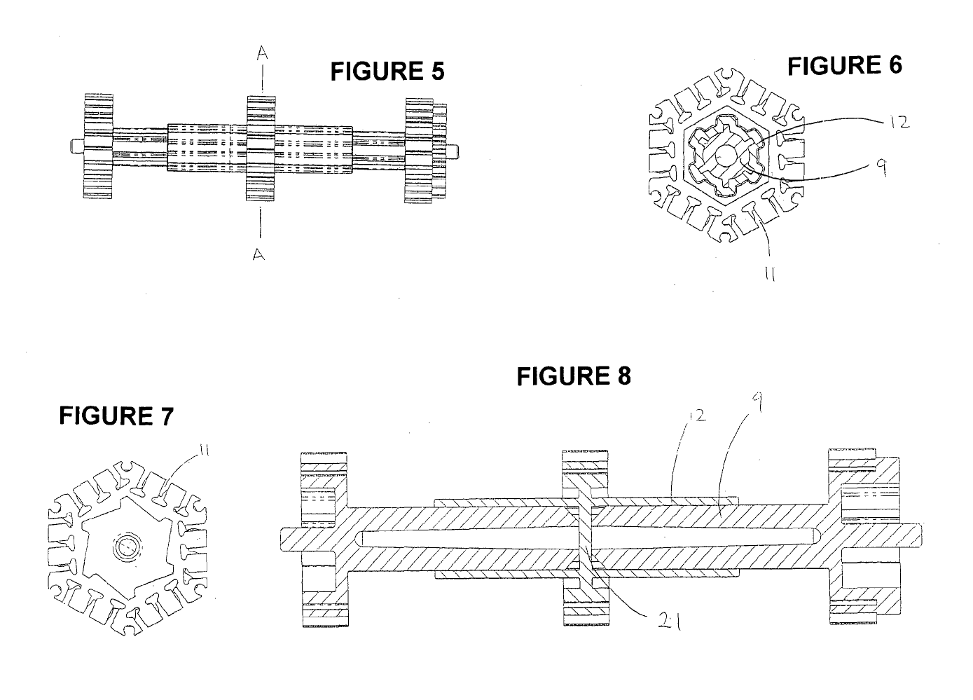

FIGS. 3 and 4 show exploded assembly views of a shaver head. The shaver head 1 may comprise a central portion 5, two end portions 6, and a blade assembly 7. The assembly of the central portion and the two end portions may define the central axle 2 and the hubs 3 extending from the central axle 2.

Each end portion 6 may have a hub 3 located at the end of an elongate shaft 9. Alternatively the hub 3 may be located at any position on the elongate shaft 9. The hub 3 and the elongate shaft 9 are preferably moulded as a unitary item. Alternatively, the hub 3 and the elongate shaft 9 may be moulded separately and fixed together.

The central portion 5 may be used to connect the two end portions 6. The central portion 5 may be adapted to receive the elongate shafts 9 in its central bore 12. There may be a complementary relationship between the central bore 12 and the elongate shafts 9 of the end portions 6 to ensure they cannot rotate relative to one another. Preferably the central bore 12 and the elongate shafts 9 are in a splined engagement with one another. Alternatively, any other method of connecting the elongate shafts 9 with the central potion 5 may be used.

The central portion 5 may have a hub 3 extending from it. Preferably the central portion 5 has a hub 3 located substantially towards its centre. Preferably the hub 3 of the central portion is moulded unitary with the central portion. Alternatively, the hub 3 and the central portion may be moulded separately and fixed together.

It is preferred that the central portion 5 and the two end portions 6 may be moulded separately and then assembled together. Alternatively, the central portion 5 and the two end portions 6 may be moulded as a unitary item.

The blades 10 of the blade assembly 7 may be located in each recess 11 of the hubs 3. The blades may be inserted into the recesses 11 using any suitable method. The recesses 11 in each hub 3 ensure the blades are held rigidly, and parallel to the longitudinal direction of the head 1.

FIG. 6 is a cross section through A-A. It shows the splined engagement of the elongate shaft 9 with the central bore 12. Each recess 11 for receiving a blade 10 is also shown. The hub 3 in FIG. 6 is hexagonal in shape. Therefore there are six sides in which blades 10 can be received. There are three recesses 11 on each side of the hub 3 for receiving three blades. Alternatively any number of blades may be located on each side of the hub 3.

FIG. 7 is an end view of the shaver head 1. The circular recesses in each corner of the hub 3 may be used to position wear strips 22. Wear strips 22 may indicate to a user that the shaver head 1 should be rotated to expose a new set of blades for use. The wear strips 22 may for example change colour after a certain period of use, to indicate that a change is required. This may be achieved by providing a paint of a different colour over the base material that is positioned to be subjected to wear from the skin of the user. Over time the paint layer thins until the base layer becomes exposed.

FIG. 8 shows a cross section through B-B. It shows the location of the elongate shafts 9 inside the central bore 12. The end of the elongate shafts 9 may be abutted against an internal strip 21.

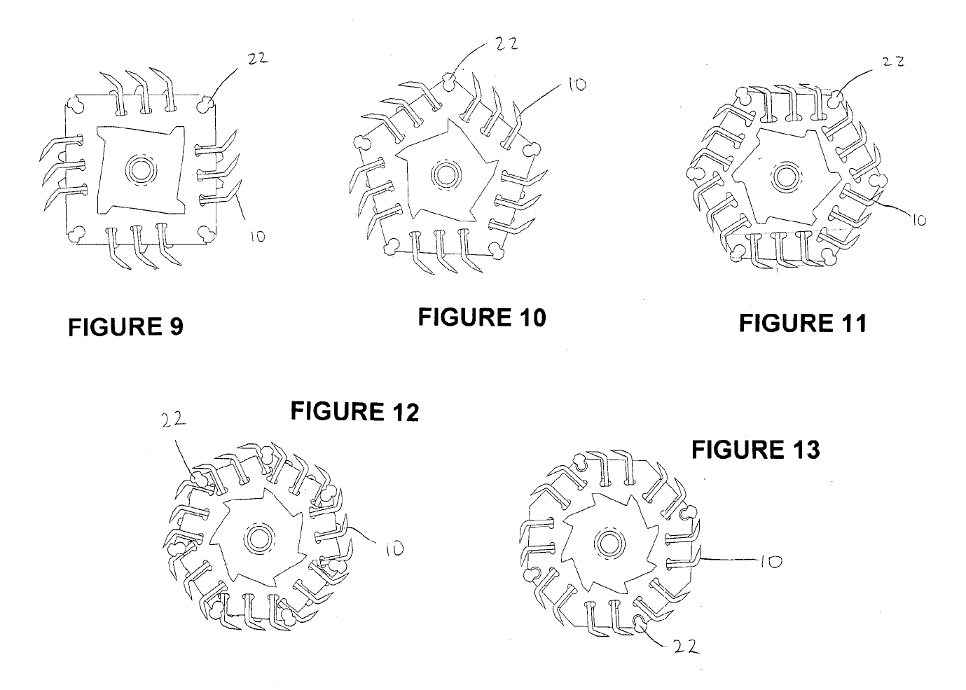

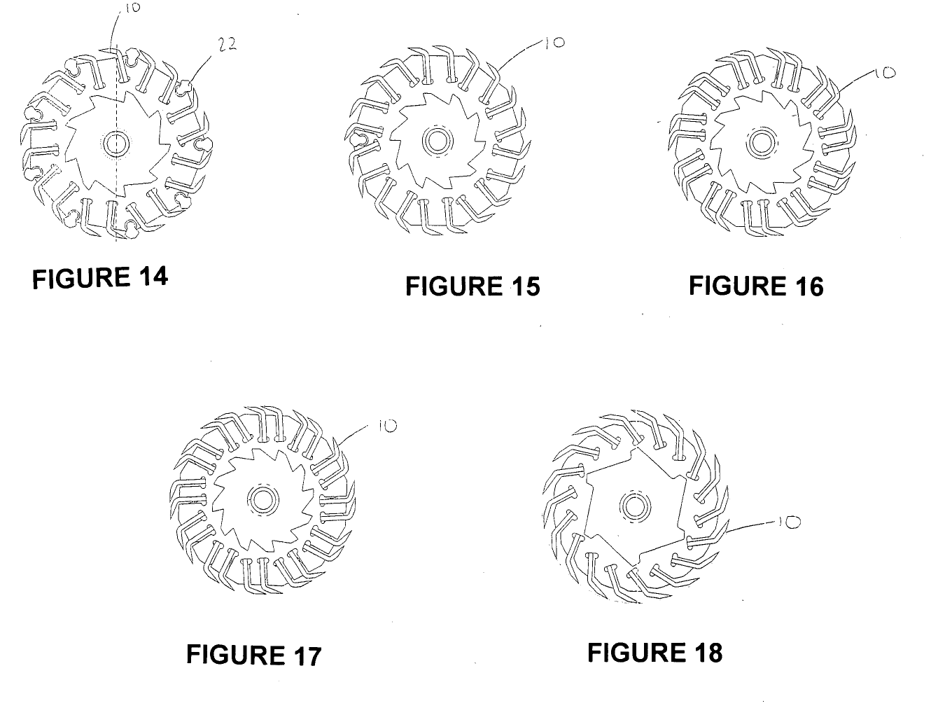

The hubs 3 which receive the blades 10 may have any number of sides. FIGS. 9 to 17 show end views of shaver heads that have hubs 3 with differing numbers of sides and differing numbers of blades 10 located thereon. Wear strips 22 may be located on the corners of each hub 3 as shown. FIGS. 9 to 17 show hubs 3 having four to twelve sides respectively.

FIG. 18 shows the end of a shaver head having a substantially round hub 3 with blades 10 located around its periphery.

The manner in which the blades are mounted to the head body allows for multiple water passages to be established when flushing the head with water. No or a reduced number of cavities exist for debris for become trapped, even during water flushing. This facilitates the cleaning of the head.

1.-18. (canceled)

19.-38. (canceled)

39. A shaver head for a rotary razor comprising: a central axle, at least two spaced apart hubs extending from said axle, wherein each hub mounts a plurality of elongate blades such that the blades are mounted in a manner to each extend, in their elongate direction, parallel to each other and parallel to the central axle.

40. A shaver head as claimed in claim 39 wherein the blades do not contact the central axle and are positioned spaced away from the central axle to facilitate a cleaning of the blades by water that can circulate between the blades and the central axle.

41. A shaver head as claimed in claim 39 wherein the blades are supported by each of the hubs only.

42. A shaver head as claimed in claim 39 wherein the blades are mounted to not contact each other.

43. A shaver head as claimed in claim 39 wherein the blades are of a sheet metal.

44. A shaver head as claimed in claim 39 wherein the central axle comprises of multiple parts each part including one of the hubs, wherein each axle part can engage with (and preferably to) the other axle parts to form a central axle assembly.

45. A shaver head as claimed in claim 39 wherein each hub is of a polygonal shape that presents at least three sides, at each of which a plurality of blades are mounted to provide a multi faceted blade head each of at least two blades that can be presented at any one time for shaving purposes.

46. A shaver head as claimed in claim 39 wherein the blades include a straight cutting edge parallel to the elongate direction.

47. A blade mount for mounting blades to define a rotary razor, said mount comprising: a central axle, at least two spaced apart hubs extending from said axle, wherein each hub is adapted to mount a plurality of elongate blades such that the blades are mounted in a manner to each extend, in their elongate direction, parallel to each other and parallel to the central axle.

48. A blade mount as claimed in claim 47 wherein the blades do not contact the central axle and are positioned spaced away from the central axle to facilitate a cleaning of the blades by water that can circulate between the blades and the central axle.

49. A blade mount as claimed in claim 47 wherein the blades are supported by each of the hubs only.

50. A blade mount as claimed in claim 47 wherein the blades can be mounted to not contact each other.

51. A blade mount as claimed in claim 47 wherein the blades are of a sheet metal.

52. A blade mount as claimed in claim 47 wherein the central axle comprises of multiple parts each part including one of the hubs, wherein each axle part can engage with (and preferably to) the other axle parts to form a central axle assembly.

53. A blade mount as claimed in claim 47 wherein each hub is of a polygonal shape that presents at least three sides, at each of which a plurality of blades can be mounted to provide a multi faceted blade head each of at least two blades that can be presented at any one time for shaving purposes.

54. A blade mount as claimed in claim 47 wherein the blades include a straight cutting edge parallel to the elongate direction.
